(19) United States
(12) Patent Application Publication
(10) Pub. No.: US 2013/0334115 A1
(43) Pub. Date: Dec. 19, 2013

(54) DEVICE FOR PRODUCING ULTRAPURE WATER ACCORDING TO THE RO (REVERSE OSMOSIS) PRINCIPLE

(71) Applicant: Manfred Völker, Blankenbach (DE)

(72) Inventor: Manfred Völker, Blankenbach (DE)

(21) Appl. No.: 13/567,192

(22) Filed: Aug. 6, 2012

(30) Foreign Application Priority Data
Jun. 13, 2012 (EP) 12 004 438.3

(51) Int. Cl. B01D 61/02

(52) U.S. Cl. 210/195.2

(57) ABSTRACT

The concentrate return line of a device for producing ultrapure water according to the reverse osmosis principle has inserted thereinto a venturi tube with the convergence chamber and the divergence chamber, with a suction hose being mounted on the suction opening of the venturi pump and being connectable by means of a coupling either upstream of the venturi pump and of a flow resistance means to the concentrate return line or to an external container which contains a disinfectant or a cleaning agent. A disinfecting process can thereby be substantially automated.

### FIELD OF THE INVENTION

The present invention refers to a device for producing ultrapure water according to the RO (reverse osmosis) principle, the device comprising an RO filter module which is subdivided by a membrane into a primary circuit and a secondary circuit, an atmospherically ventilated feed tank in which a raw-water supply line terminates, with a line, which has inserted therein a pump, leading from the lower end of the feed tank to the primary circuit, a concentrate return line leading from the primary circuit back to the feed tank, and a permeate line, to which dialysis devices are connectable, extending from the secondary circuit.

### BACKGROUND

Reverse osmosis systems of such a type serve to recover pure sterile water from tap water e.g. for medical and food-technological applications. Their operative principle consists in guiding the water to be prepared in a filter module under high pressure along the surface of a semi-permeable membrane, with part of the water, the permeate, passing through the membrane and being collected at the other side of the membrane and supplied to the consumption point, e.g. to one or several dialysis devices. The part of the raw water which does not pass through the membrane and is enriched with retained substances, i.e. the concentrate, flows at the end of the flow path of the primary circuit out of the filter module. To keep the water consumption of the reverse osmosis system as small as possible, part of the concentrate is mostly returned to the feed tank.

The line system, particularly the one with the concentrate returned to the feed tank, is not free of organic impurities. Without special counter-measures, a colonization of said liquid system, i.e. of the feed tank and the lines leading to the filter module and from there back to the feed tank, may therefore occur. A so-called biofilm would deposit in this process on the inner surfaces of the liquid-conducting system.

To prevent such a situation, said part of the liquid system of the reverse osmosis facility has to be disinfected at suitable intervals. To this end the normal operation is interrupted and a chemical disinfectant is supplied to the liquid-conducting system. After a suitable exposure time a flushing operation is carried out, said operation serving to remove the introduced disinfectant and its reaction products again, so that the normal supply operation can be resumed thereafter.

Due to the great risks that would be posed by an uncontrolled supply of disinfectant, especially when used in the medical sector (hemodialysis), all of the operating steps that are needed for performing the disinfecting process have so far been carried out manually under the complete control of the operating personnel. This includes inter alia the establishment and later separation of a connection line with an external disinfectant container and the monitoring of the correct supply of the disinfectant.

### SUMMARY

It is the object of the present invention to substantially automate the conduction of a disinfecting process of the type under consideration.

This object is achieved according to the invention by a device for producing ultrapure water according to the RO (reverse osmosis) principle as more fully disclosed herein below.

According to the invention the concentrate return line has inserted thereinto a venturi pump or venturi tube with the convergence chamber and the divergence chamber, with a suction hose being mounted on the suction opening of the venturi pump and being connectable by means of a coupling either upstream of the venturi pump and preferably of a flow resistance means to the concentrate return line or to an external container which contains a disinfectant or a cleaning agent. The coupling is preferably a plug-type coupling which includes two coupling members which can be plugged together, the stationary member of the coupling being automatically closed by spring force when disengaged.

It is suggested with great advantage that a respective stationary coupling member should be arranged on the container and on the concentrate return line and an associated counter-coupling member should be arranged on the end of the suction hose. Each of the stationary coupling members is preferably provided with a reed contact, and a ring magnet is arranged on the counter-coupling member so that upon connection or disconnection of the suction hose the reed switch formed in this way performs a switching operation which is used as a control signal for the reverse osmosis system.

During normal RO operation the suction hose is connected to the concentrate return line in that the two coupling members are plugged into each other and the reed switch is closed. Part of the concentrate flows through the suction hose due to the flow resistance downstream of the branch-off point, whereby said hose is permanently flushed.

When a disinfecting operation is to be carried out, the plug-type coupling on the concentrate return line is decoupled, which entails a switching operation of the reed switch. This switching operation is used with great advantage as a control signal for automatically interrupting the normal operation. When at the end of the flexible suction hose the coupling element is subsequently plugged together with the coupling element on the external container, a switching operation of the reed switch can be detected—on condition that a corresponding reed switch is here arranged, whereupon a disinfecting operation is started preferably automatically. Disinfectant can be sucked into the venturi pump e.g. for a predetermined period of time, or said suction operation is carried out for such a long time until an analysis device arranged in the primary and/or in the secondary circuit detects a predetermined concentration of the disinfectant in the liquid to be cleaned. Volumetric metering which is monitored by level switches in feed tanks is also possible. After an appropriate exposure time a flushing operation is carried out preferably automatically after the renewed replugging of the suction hose so as to remove the introduced disinfectant and its reaction products again, so that the normal supply operation can subsequently be resumed again.

With the present invention the disinfecting operation can be carried out substantially automatically, whereby the safety-relevant preconditions are considerably improved.

The atmospherically ventilated container is particularly prone to colonization by microorganisms. Both the raw water supply line and the concentrate return line and most of the time also a permeate return line that partly fill the feed tank terminate in said feed tank, normally through its lid. The fill level is normally detected by a means used for level detection of the respective fill level.

To avoid colonization of the inner wall of the feed tank with a biofilm or to eliminate already deposited microorganisms, it is suggested under a different aspect of the present invention, which is independent of the type of introduction of the disinfectant into the concentrate return line, that a distribution means or a deflection means for the liquid jets should be arranged on or under the mouth of the lines terminating in the feed tank and should direct the liquid entering into the feed tank against the inner wall of the feed tank, so that the liquid will flow downwards along the inner wall of the feed tank. Organic deposits on the inner wall of the feed tank are reliably prevented thereby and the wall surfaces of the feed tank are completely flushed or washed.

The distribution means or deflection means may be a distribution screen of a suitable size which slopes substantially conically outwards, or e.g. atomizing nozzles which direct the liquid jets against the inner wall of the feed tank.

It may also be provided that a respective one of the above-mentioned distribution devices or, preferably, a joint, substantially conical distribution screen is arranged under the mouth of the water supply line, the concentrate return line and the permeate return line into the feed tank.

Under another independent aspect of the present invention the venturi pump may be composed of at least two blocks with flow channels which are closely connected to one another—preferably with interposition of O-ring seals. The blocks consist preferably of a hard plastic. Such a modular construction of the venturi pump permits the inexpensive manufacture of venturi pumps of different sizes and shapes by assembling prefabricated elements according to the modular design principle.

According to another proposal of the invention a venturi pump assembled in this way is fastened to the lid of the feed tank.

### BRIEF DESCRIPTION OF THE DRAWINGS

The present invention shall now be described in more detail with reference to the attached drawings, in which:

FIG. 1 shows the scheme of an RO system according to the invention;

FIG. 2 shows the area of the venturi pump of FIG. 1 on an enlarged scale;

FIG. 3 shows the sub-portion of the mouth of the concentrate return line into the feed tank with venturi pump fastened to the lid thereof, including a large distributor screen; and

FIG. 4 is a similar illustration with a small distributor screen.

### DETAILED DESCRIPTION OF PREFERRED EMBODIMENTS

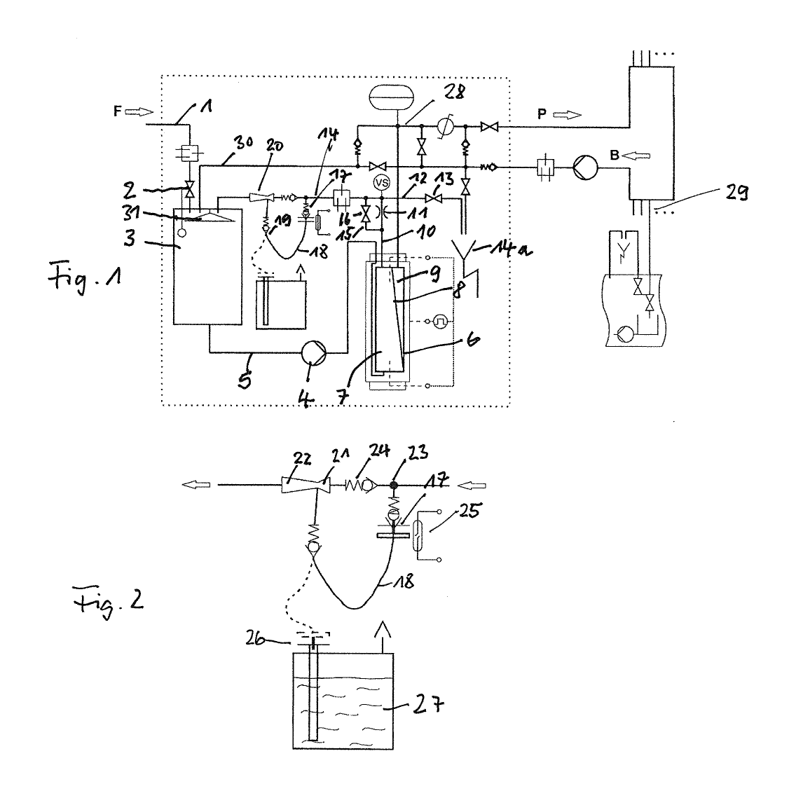

Reference is first of all made to FIG. 1. Raw water is supplied through a line 1 and passes via an inlet valve 2 into the feed tank 3. The liquid in the feed tank 3 is supplied by means of a pump 4 through a line 5 to an RO filter module the primary circuit 7 of which is separated by a membrane 8 from the secondary circuit 9.

The liquid first passes in this process into a surrounding annular chamber on the upper edge portion of the module tube and then flows along the whole inner wall downwards, so that the filter module is without any dead space and no biofilm can deposit therein.

Concentrate is discharged out of the primary circuit 7 through a line 10 in which a throttle 11 provides the pressure prevailing in the primary circuit 7. The concentrate can either be discharged into an outlet 14a through a line 12 in which a valve 13 is disposed, or can be returned through a concentrate return line 14 into the feed tank 3. The throttle 11 can be bridged by a bypass line 15 with a valve 16 so as to increase, on the one hand, the flow through the line 14 when disinfectant is sucked in, or also to discharge residues of the primary side to the outlet 14a.

The concentrate return line 14 has arranged thereon a coupling 17 which can be composed of a stationary coupling element that is firmly connected to the line 14, and of a counter-coupling element that is mounted on the end of a flexible suction tube 18. A non-return valve 19 is interposed in the suction hose 18. The suction hose 18 is fastened to the suction opening of a venturi pump 20 the convergence chamber 21 and divergence chamber 22 of which are interposed into line 14. A flow resistance means 24 is arranged between the venturi pump 20 and the branch-off point 23, with the consequence that in the closed state of coupling 17 and during normal operation of the RO system a partial amount of the concentrate flows through the suction hose 18 to the venturi pump 20.

The coupling member which is stationarily fastened to the line 14 is provided with a reed contact while the counter-coupling member mounted on the end of the suction tube 18 carries a ring magnet. The two components jointly form a reed switch 25, the switching position of which has a controlling and monitoring function for the RO system. When the coupling 17 is opened, i.e., the suction hose 18 is removed, the normal operation of the RO system is automatically interrupted.

The counter-coupling element at the end of the suction tube 18 can be plugged together with a corresponding coupling element 26 to an external container 27 which contains a disinfectant or cleaning agent. A corresponding reed switch may here also output a control signal which indicates the closing of the coupling. An automatic disinfection program can thereby be started.

Permeate flows out of the secondary circuit 9 of the RO filter module through a ring line 28 to the withdrawal points 29 for dialysis devices. Permeate that is not needed flows back through a permeate return line 30 into the feed tank 3.

A substantially conical distributor screen 32 is arranged underneath the inlet openings of the water supply line 1, the permeate return line 30 and the concentrate return line 12, and the supplied liquids impinge on said screen and are directed by the distributor screen 31 against the inner wall of the feed tank 3. As a result, liquid flows permanently downwards on the inner wall of the feed tank 3, so that no biofilm can deposit there. Moreover, with each disinfecting process, entrained disinfectant is guided to the inner wall. In the subsequent flushing program the disinfectant is removed without any residues from the inner surface of the feed tank.

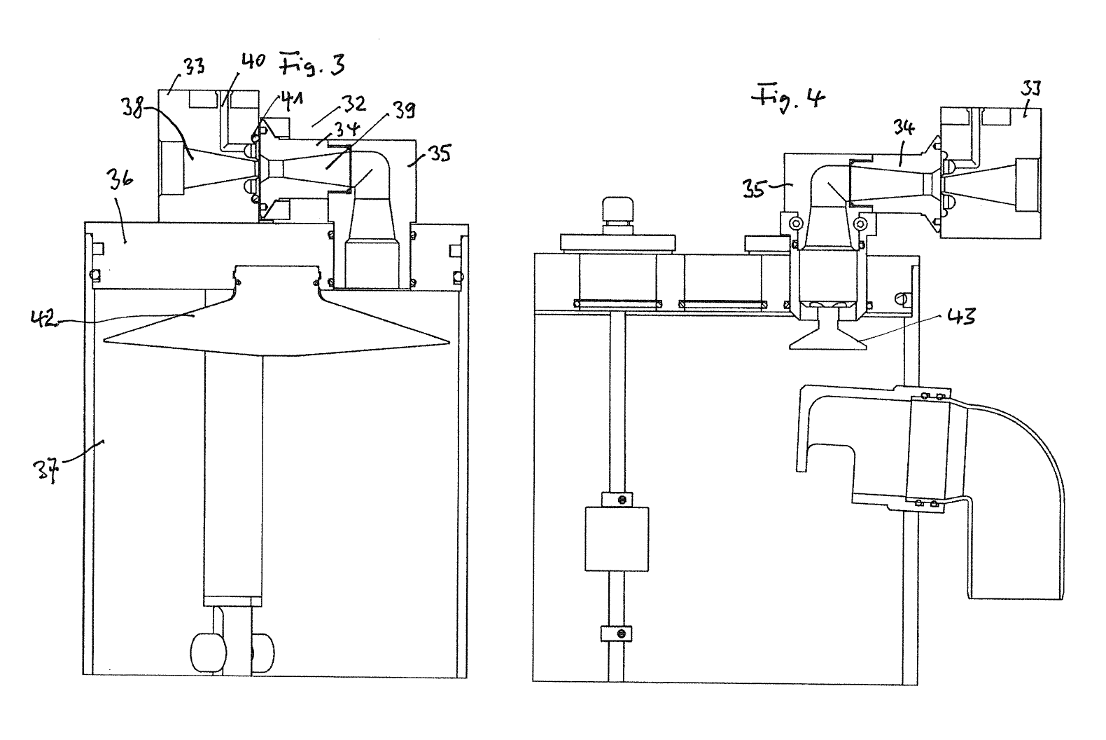

FIG. 3 shows that a venturi pump 32 may be composed of two blocks 33 and 34, with a further block 35 forming the concentrate inlet through a lid 36 of the feed tank 37. The blocks 33 to 35 consist preferably of a hard plastic. The convergence chamber 38 is put together with the divergence chamber 39, and a suction channel 40 terminates in the central suction portion. The blocks 33 to 35 are fastened to one another with the help of suitable means with interposition of 0-sealing rings 41. A substantially conical deflection/distributor screen 42 which directs the impinging liquid against the inner wall of the feed tank 37 is fastened underneath the lid 36.

In the embodiment illustrated in FIG. 4, a small deflection screen 43 is arranged for the same purpose at the inlet of the concentrate return line by way of example for all liquids terminating in the feed tank.

1. A device for producing ultrapure water according to the RO (reverse osmosis) principle, comprising an RO filter module which is subdivided by a membrane into a primary circuit and a secondary circuit, an atmospherically ventilated feed tank into which a water supply line terminates, with a line, which has inserted therein a pump, leading from the lower end of the feed tank to the primary circuit, a concentrate return line leading from the primary circuit back to the feed tank, and a permeate line, to which dialysis devices are connectable, extending from the secondary circuit, wherein the concentrate return line has inserted therein a venturi pump with its convergence chamber and divergence chamber into which a suction hose terminates that is selectively connectable by means of a plug-type coupling with coupling members automatically closing when disengaged on the stationary members to a container containing disinfectant and/or cleaning agent or upstream of the venturi pump to the concentrate return line.

2. The device according to claim 1, wherein a permeate return line terminates in the feed tank.

3. The device according to claim 1, wherein upstream of the venturi pump a flow resistance means is inserted into the concentrate return line.

4. The device according to claim 1, wherein a respective stationary coupling member is arranged on the container and on the concentrate return line and an associated counter-coupling member is arranged on the end of the suction hose.

5. The device according to claim 4, wherein a respective reed contact is arranged on the stationary coupling members and a ring magnet is arranged on the counter-coupling member and that the connection or disconnection of the suction hose is detected and used as control signal of the RO.

6. The device according to claim 1, wherein a non-return valve is interposed in the suction hose.

7. The device according to claim 1, wherein a distribution means or deflection means for the liquid jet which directs the entering liquid against the inner wall of the feed tank is arranged on or under the mouth of the concentrate return line into the feed tank.

8. The device according to claim 7, wherein the distribution means is a nozzle means and/or a substantially conical distribution screen.

9. The device according to claim 1, wherein a respective distribution means or a joint, substantially conical, distribution screen is arranged under the mouth of the water supply line, the concentrate return line and the permeate return line into the feed tank.

10. The device according to claim 1, wherein the venturi pump is composed of at least two blocks with flow channels which are closely connected to one another.

11. The device according to claim 10, wherein the venturi pump is fastened to a lid of the feed tank.

12. The device according to claim 4, wherein a non-return valve is interposed in the suction hose.

13. The device according to claim 5, wherein a non-return valve is interposed in the suction hose.
